(19) United States
(12) Patent Application Publication
(10) Pub. No.: US 2017/0106721 A1
(43) Pub. Date: Apr. 20, 2017

(54) ENERGY-EFFICIENT VEHICLE WINDOW DEFOGGING AND PREVENTION OF RE-FREEZING

(71) Applicant: FORD GLOBAL TECHNOLOGIES, LLC, Dearborn, MI (US)

(72) Inventors: Paul Bryan Hoke, Plymouth, MI (US); James R. Hurd, III, Northville, MI (US)

(21) Appl. No.: 14/884,472

(22) Filed: Oct. 15, 2015

(51) Int. Cl. B60H 1/00; B60S 1/02; B60S 1/54; B60J 1/00

(52) U.S. Cl. CPC B60H 1/00785; B60J 1/002; B60S 1/023; B60S 1/54

(57) ABSTRACT

A method for preventing vehicle windscreen fogging or re-freezing includes calculating a windscreen interior surface dew point temperature value and/or windscreen interior surface fogging and/or exterior surface re-freezing probability value, and providing only a sufficient conditioned airflow to the windscreen to prevent the calculated probability value from exceeding a predetermined fogging and/or re-freezing risk threshold value. One or more controllers perform the calculating, and actuate elements of a vehicle HVAC system to provide only a sufficient conditioned airflow to cause a windscreen interior surface temperature value to exceed the windscreen interior surface dew point temperature value or to cause a windscreen exterior surface temperature value to exceed a windscreen exterior surface freezing temperature. Inputs influencing the windscreen interior surface fogging and/or exterior surface re-freezing probability value and/or the windscreen direct dew point temperature value are used to adjust the threshold values. Systems for accomplishing the described methods are provided.

### TECHNICAL FIELD

This disclosure relates generally to vehicle heating, ventilation, and air conditioning (HVAC) system operation. More particularly, the disclosure relates to energy-efficient systems and methods for vehicle window defogging and for prevention of window refreezing.

### BACKGROUND

During motor vehicle operation, often external and internal climate conditions combine to lead to window fogging and/or re-freezing. That is, after an initial warm-up phase of operation of the vehicle during which typically the vehicle windscreen, side windows, etc. are defogged and/or de-iced, in part by use of the vehicle heating, ventilation, and air-conditioning (HVAC) system. However, during vehicle operation conditions may be conducive to window fogging and/or re-freezing. For example, exterior ambient temperatures may be sufficiently cold and passenger cabin conditions may be sufficiently warm and humid to promote condensation on one or more of the windows, leading to windscreen fogging and/or re-freezing.

A conventional solution to this problem is to continuously divert a portion of a conditioned airflow from the HVAC system to one or more of the windows to prevent window fogging/re-freezing during vehicle operation. While substantially effective, such constant airflow bleed from the HVAC system can have negative consequences, including additional undesired noise, vibration, etc. from airflow and increased HVAC blower load, undesirably increased temperatures in an upper portion of the vehicle passenger cabin, passenger “dry eye” from constant air flow, and others.

Moreover, the HVAC system is a critical element of the modern motor vehicle for other reasons than defogging/de-icing. Efficient HVAC performance is required in all environments for vehicle occupant comfort and for all weather visibility issues. In turn, efficient HVAC performance is increasingly a concern for overall vehicle energy management which also affects fuel economy in combustion engine-driven vehicles and hybrid vehicles, and range and electrical power budget in electric vehicles and hybrids. Continuously directing airflow to a window during vehicle operation can impose a significant and potentially excessive energy usage which may undesirably impact the vehicle's overall energy budget.

To solve this and other problems, the present disclosure relates at a high level to energy-efficient systems and methods for vehicle window defogging and for prevention of window refreezing. Advantageously, the described systems and methods incorporate consideration of various inputs relevant to conditions conducive to window fogging/re-freezing. According to those inputs, sufficient levels of conditioned air are directed to the window. By the described systems/methods, diversion of conditioned airflow to the vehicle window is substantially restricted to periods of vehicle operation when interior/exterior conditions are deemed conducive to window fogging/re-freezing rather than simply directing a continuous stream of conditioned air to a window to prevent fogging/re-freezing with the attendant disadvantages described above.

### SUMMARY

In accordance with the purposes and benefits described herein, in one aspect a method for prevention of fogging or re-freezing of a vehicle windscreen is described that includes, by one or more controllers, calculating a windscreen interior surface dew point temperature value and/or a probability value of a windscreen interior surface fogging and/or exterior surface re-freezing. Then only a sufficient conditioned airflow is provided to the windscreen to prevent the calculated fogging and/or re-freezing probability value from exceeding a predetermined fogging and/or re-freezing risk threshold value. In embodiments, this occurs after an initial passenger cabin warm-up period and during operation of the vehicle HVAC system in a floor mode.

In an embodiment, only a sufficient conditioned airflow is provided to cause a windscreen interior surface temperature value to exceed the windscreen interior surface dew point temperature value or to cause a windscreen exterior surface temperature value to exceed a windscreen exterior surface freezing temperature. The windscreen interior surface dew point temperature value or windscreen exterior surface temperature value may be adjusted by a variety of inputs, including exterior and interior climate-related inputs, vehicle occupant inputs, remote inputs, and others.

In another aspect, a system is provided for prevention of fogging or re-freezing of a vehicle windscreen according to the above described methods, including one or more controllers and a vehicle heating, ventilation, and cooling (HVAC) system including at least one actuator operatively connected to the one or more controllers and to at least one door associated with at least one windscreen defrost duct. The one or more controllers are configured to calculate a windscreen interior surface dew point temperature value and/or a probability value of a windscreen interior surface fogging and/or exterior surface re-freezing, and to cause the HVAC system to provide only a sufficient conditioned airflow to the windscreen to prevent the calculated fogging and/or re-freezing probability value from exceeding a predetermined fogging and/or re-freezing risk threshold value. The one or more controllers are further configured to translate the door between a closed configuration, a fully open configuration, and at least one intermediate configuration to regulate airflow volume to the windscreen.

In embodiments, a variety of devices are provided in the system for providing or receiving the exterior and interior climate-related inputs, vehicle occupant inputs, remote inputs, and others. These include without intending any limitation various sensors such as sun load/direction sensors, rain sensors, passenger cabin relative humidity sensors, windscreen relative humidity sensors, windscreen interior surface temperature sensors, windscreen exterior surface temperature sensors, passenger cabin temperature sensors, vehicle occupant sensors, vehicle speed sensors, wind speed/direction sensors, vehicle-associated exterior ambient temperature sensors, and others. Other contemplated devices include an HVAC system control panel, an electronic automatic temperature control (EATC) module, receivers for remote temperature data, receivers for remote humidity data, receivers for crowd-sourced data, and others.

In the following description, there are shown and described embodiments of the disclosed energy-efficient systems and methods for vehicle window defogging and for prevention of window refreezing. As it should be realized, the systems/methods are capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed energy-efficient systems and methods for vehicle window defogging and for prevention of window refreezing, and together with the description serve to explain certain principles thereof. In the drawings:

FIG. 1 schematically depicts a prior art HVAC system for a vehicle;

FIG. 2 depicts a system for vehicle window defogging and for prevention of window refreezing according to the present disclosure;

FIG. 3 depicts in flow chart form a method for vehicle window defogging according to the present disclosure; and

FIG. 4 depicts in flow chart form a method for prevention of window refreezing according to the present disclosure.

Reference will now be made in detail to embodiments of the disclosed systems and methods for vehicle window defogging and for prevention of window refreezing, examples of which are illustrated in the accompanying drawing figures wherein like reference numerals identify like features.

### DETAILED DESCRIPTION

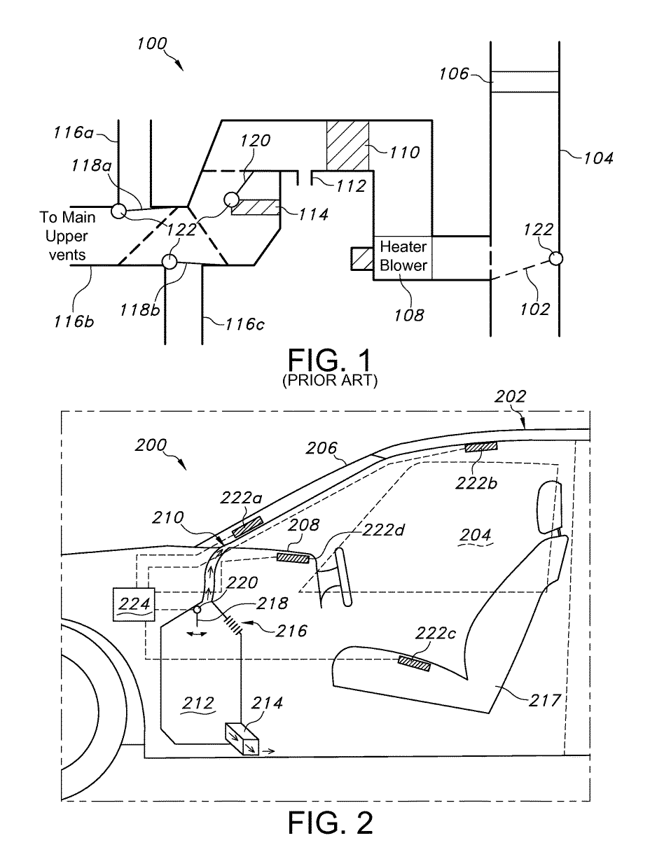

Reference is now made to FIG. 1 schematically illustrating a vehicle HVAC system 100. As will be appreciated, specific designs of HVAC system may vary, and so the illustrated system is representative only and not to be taken as limiting. As shown, a recirculation flap 102 determines whether air is taken from a duct 104 leading from an exterior of the vehicle passenger cabin or whether passenger cabin air is recirculated through the HVAC system. Exterior air must typically pass through a cabin air filter 106 to ensure that only clean air enters the HVAC system 100 and the vehicle occupant's lungs. A blower motor 108 provides air movement through the HVAC system 100. A number of blower 108 designs are known, including electronic blower motors using pulse width modulation (PWM). As is known, such electronic blower motors can provide a nearly infinite number of fan speeds to regulate airflow speed through the system 100.

Air passing through the HVAC system 100 also typically passes through an evaporator core 110 for cooling/dehumidifying if the vehicle air-conditioning system is activated. Certain HVAC systems activate the air-conditioning system to dehumidify air passing through the system even if the air is to be subsequently warmed. An evaporator drain 112 may be included to allow discharge of condensate generated during the process of dehumidifying air passing through the HVAC system. A heater core 114 is provided to increase the temperature of the air passing through the HVAC system 100 if the vehicle heating system is activated, and as is known is substantially a small radiator in design and effect.

An HVAC system 100 also usually includes at least ducts 116a, 116b, 116c leading respectively to one or more defrost vents (not shown), one or more passenger cabin main upper vents (not shown), and one or more passenger cabin floor vents (not shown). Actuable mode doors 118a, 118b control the direction of airflow through the HVAC system 100, i.e. whether conditioned air is directed to the defrost vents (defrost mode), to the floor vents (floor mode), to the main upper vents, or combinations. A blend door 120 controls the amount of airflow passing through the heater core 114. As is known, this in turn determines the warmth of the air reaching the various vehicle vents. Actuators 122 control the translation of mode doors 118a, 118b and blend door 120 from an open configuration to a closed configuration. Various actuator designs are known in the art, including cable style actuators, vacuum-driven actuators, electronic stepper motors, and others.

Representative settings provided by the mode doors 118a, 118b and blend door 120 include full heat (the blend door 120 diverts all airflow through the heater core 114), economy mode (blend door 120 diverts all airflow past the heater core 114 but the vehicle air-conditioning system is not activated), and max air-conditioning (blend door 120 diverts all airflow past the heater core 114 and the vehicle air-conditioning system is activated).

Other devices may be incorporated into or operatively connected to the HVAC system 100, including passenger cabin air temperature sensors (not shown) and vent/outlet temperature sensors (not shown) for providing accurate passenger cabin and air temperature values, allowing fine-tuned control of the HVAC elements described above for precise passenger cabin temperature/humidity control. In turn, it is known to provide dual zone/quad zone HVAC systems including divided mode doors and separate plenums, to allow providing different temperature settings to different portions of the vehicle passenger cabin.

With the foregoing as background, as summarized above the present disclosure is directed to methods for preventing fogging and/or re-freezing of a vehicle window such as a windscreen or others, and to systems for implementing the methods. At a high level, the methods comprise, after an initial vehicle passenger cabin warm-up, determining whether a risk of windscreen fogging/re-freezing requires providing a sufficient conditioned airflow to the windscreen to prevent/reduce the risk of such fogging/re-freezing. As will be appreciated, as used herein “conditioned” refers to adjusting a temperature and/or a humidity of air passing through the vehicle HVAC system as required according to ambient and/or passenger cabin conditions of temperature, humidity, etc. As will also be appreciated, as used herein the term “sufficient” refers to an airflow speed, air temperature, air humidity, or combinations thereof necessary to negate the determined risk of fogging/re-freezing. In one embodiment, on determining a risk of windscreen fogging/re-freezing, according to the described method a determination is made of whether a full air bleed, i.e. full airflow, to the windscreen is required, whether a reduced air bleed is satisfactory, or whether no air bleed to the windscreen is required.

In determining the risk of fogging/re-freezing, according to the described methods a variety of inputs that may influence or increase the risk of windscreen fogging/re-freezing may be considered. Without intending any limitation, these inputs may include sun load/direction, rain, passenger cabin relative humidity, windscreen interior or exterior relative humidity, windscreen interior surface temperature, windscreen exterior surface temperature, passenger cabin temperature, number of vehicle occupants, vehicle speed/rate of travel, wind speed/direction, exterior ambient temperature, data/input provided by a vehicle occupant, remotely generated temperature information, remotely generated relative humidity information, and crowd-sourced data. By these and other inputs a determination may be provided of a risk of windscreen fogging/re-freezing, allowing an informed decision as to whether a conditioned airflow should be provided to the vehicle windscreen, if so for how long, and even potentially of specific parameters (temperature, relative humidity, etc.) of the conditioned air so provided. By this expedient, energy usage is conserved compared to simply providing a constant flow of conditioned air to the windscreen as is common in conventional strategies for reducing risk of windscreen fogging/re-freezing.

In more detail, the described methods comprise use of various inputs as summarized above in calculating one or more of a windscreen fogging probability, a windscreen direct dew point, and a windscreen and/or windscreen wiper freezing risk value or probability value. That probability value is then compared against a suitable benchmark or threshold value, and from that comparison a determination is made of whether a full air bleed, a partial air bleed, or no air bleed from an HVAC airflow is required to reduce the determined fogging/re-freezing risk value to an acceptable level.

FIG. 2 depicts in schematic form a representative system 200 for accomplishing the described methods. A vehicle 202 defines at least a passenger cabin 204 and includes a windscreen 206 and a dash panel 208. Dash panel 208 includes at least one defrost duct/vent 210 through which conditioned air may be directed (see arrows) from an HVAC system depicted generally as ref. num. 212 (see the discussion above of FIG. 1) to an interior surface of windscreen 206. One or more floor outlets 214 are provided for directing conditioned air (see arrows) from the HVAC system 212 to a floor portion of the passenger cabin 204. One or more panel ducts/vents 216 are provided through which conditioned air is directed into the passenger cabin 204. One or more driver/passenger seats 217 are included.

A defrost flow control door 218 (see the discussion above of FIG. 1 and mode doors 118) is provided under the control of an actuator 220. As described above, this may be any suitable actuator, including without limitation cable style actuators, vacuum-driven actuators, electronic stepper motors, and others. A variety of sensors, depicted generally as sensors 222ₐ . . . 222ₙ, are provided for obtaining various inputs. As is known, such sensors may be direct (contact) or indirect sensors. In turn, one or more controllers 224 are provided for receiving and processing inputs from sensors 222ₐ . . . 222ₙ by wireless or wired means, and for controlling various aspects of HVAC system 212, actuator 220, and others.

Without intending any limitation, examples of sensors 222 contemplated for inclusion in the present system 200 include sun load/direction sensors, rain sensors, passenger cabin relative humidity sensors, windscreen relative humidity sensors, windscreen interior surface temperature sensors, windscreen exterior surface temperature sensors, passenger cabin temperature sensors, vehicle occupant sensors, vehicle speed sensors, wind speed/direction sensors, vehicle-associated exterior ambient temperature sensors, and others. It will be appreciated that a number of designs for each of the above-described sensors are known in the art, and inclusion of any such suitable sensor is contemplated herein. As non-limiting examples, rain sensors based on a principle of total internal reflection of an infrared light beam are well known for detecting rainfall, and are often used in conjunction with a controller 224 to automatically actuate vehicle 202 wiper blades. Likewise, a variety of temperature and relative humidity sensors are known in the art. Still more, various passenger or vehicle occupant sensors are known, including pressure sensors associated with passenger seat 217, sensors associated with vehicle seat belt buckles, camera systems connected to controllers including logic for detecting vehicle occupants, etc.

Inputs gathered by the described sensors 222ₐ . . . 222ₙ, as well as potentially other inputs provided to controller 224 including vehicle occupant input such as manual actuation or programming of HVAC system 212, manual or automatic wiper blade actuation, remote temperature data, remote relative humidity data, etc., are provided to controller 224, which in turn utilizes those inputs to accomplish the methods of the present disclosure.

In an embodiment of a method according to the disclosure, a suitable windscreen fogging benchmark or threshold value is a windscreen dew point temperature (T_{DEWPOINT}), i.e. the temperature and/or relative humidity at which moisture begins to condense on the vehicle windscreen. A determination is made of the amount of conditioned air (if any) required to raise an interior temperature of the windscreen (T_{GLASSint}) to above the threshold T_{DEWPOINT}.

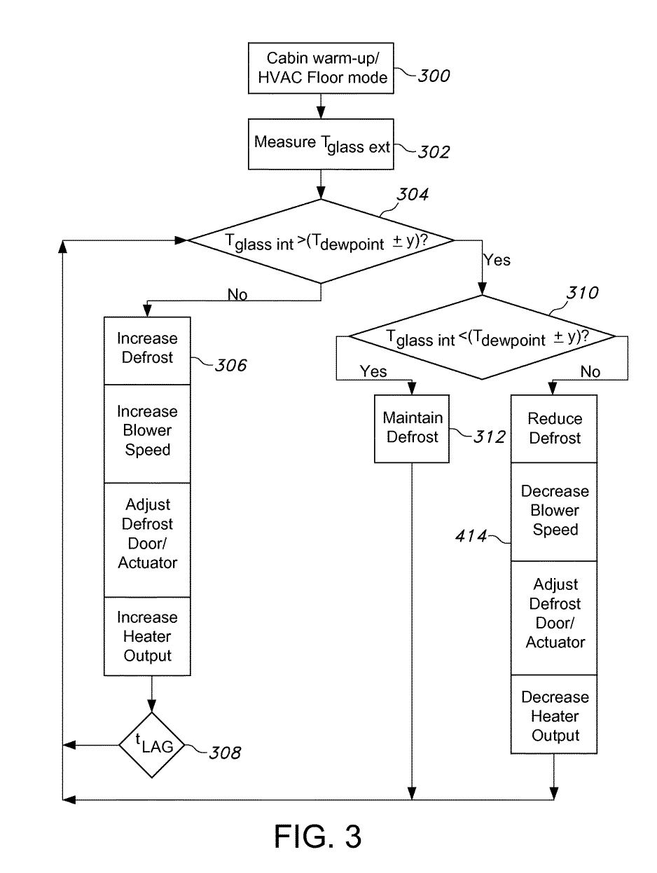

In more detail and with reference to FIG. 3, in the described embodiment a method for windscreen internal fogging prevention includes, after passenger cabin warm-up and optionally activation of an HVAC system floor mode [which may be accomplished manually by a vehicle occupant, automatically such as by an electronic automatic temperature control module (EATC) module, etc.] (step 300), determining T_{GLASSint} (step 302) such as by a suitable temperature sensor 222a as described above. As is known, such sensors may be direct (contact) sensors, indirect sensors such as infrared temperature sensors, and others. Next, a determination is made as to whether T_{GLASSint}>T_{DEWPOINT} (step 304). If not, at step 306 a defrost function is increased including diverting airflow from the HVAC floor duct 116c (see FIG. 1) by way of defrost flow control door 218/actuator 220 (see FIG. 2). The step of increasing a defrost function may further include one or more of increasing an HVAC blower 108 speed and increasing heater core 110 output. After a predetermined time interval (t_{lag}; step 308), steps 304 and 306 are repeated.

If T_{GLASSint}>T_{DEWPOINT}, at step 310 after a predetermined time period a determination is made whether T_{GLASSint}<T_{DEWPOINT}. If so, a current defrost flow is maintained (step 312) to continue to increase T_{GLASSint}. If at step 312 T_{GLASSint}>T_{DEWPOINT}, this indicates that the risk of fogging is reduced and that the defrost flow may be safely reduced (step 314), such as (with reference to FIG. 2) by one or more of adjusting the HVAC 212 blower speed, by adjusting defrost flow control door 218 to decrease the airflow to windscreen 206, by reducing the HVAC 212 heater core output, etc. In this manner, defrost flow is maintained only sufficiently to keep T_{GLASSint}>T_{DEWPOINT}, thus avoiding the need for a constant increased defrost airflow and attendant energy costs and other disadvantages as summarized above.

As will be appreciated and as will be discussed further below, the fogging threshold value T_{DEWPOINT} may be adjusted as necessary according to other inputs influencing T_{DEWPOINT}, in non-limiting examples including sun load/direction, rain, passenger cabin relative humidity, windscreen interior or exterior relative humidity, windscreen interior surface temperature, windscreen exterior surface temperature, passenger cabin temperature, number of vehicle occupants, vehicle speed/rate of travel, wind speed/direction, exterior ambient temperature, and others.

In an embodiment wherein T_{DEWPOINT} is established as the fogging benchmark or threshold value, the described method contemplates adjusting that threshold value according to measured vehicle speed (V_{SPEED}), measured exterior ambient temperature (T_{EXT}), and defroster flow rate (DEF FLOW), and defroster temperature (T_{DEF}) according to a formula:

T_{GLASSint}=[(V_{SPEED})·(T_{EXT})]+[(DEF FLOW)·(T_{DEF})]/(V_{SPEED})+(DEF FLOW) (1)

As will be appreciated, this accounts for the fact that as vehicle speed increases, the interior glass temperature begins to approach the exterior ambient temperature, whereby TENT could potentially fall below T_{DEWPOINT}. To adjust for this, according to the method the system could do one or both of increasing the defroster flow rate and increasing the defroster temperature. T_{GLASSint} could be estimated analytically, measured directly such as by an infrared camera or other suitable means, or estimated by taking a limited number of on-glass sensor readings and interpolating T_{GLASSint} by calculation or by calibration data.

Of course, T_{DEWPOINT} could be perfectly calculated if temperature and humidity could be exactly determined at every point in the vehicle passenger cabin 204. However, in actuality a vehicle usually includes a limited number of sensors, for example one temperature and one humidity sensor by cluster. Thus, typically T_{DEWPOINT} is estimated. In an embodiment, T_{DEWPOINT} may be estimated according one or more of the formulae:

T_{DEWPOINT}=T_{DEWPOINT}(Temperature, percent relative humidity)ᵢₙₜₑᵣᵢₒᵣ+C₁ (number of vehicle occupants (2); or

T_{DEWPOINT}=T_{DEWPOINT} (Temperature, percent relative humidity)ᵢₙₜₑᵣᵢₒᵣ+C₁ (number of vehicle occupants+C₂(V_{SPEED}) (3); or

(2) or (3)+C₃ (rain sensor signal) (4).

Of course, still other factors could be considered as described above including without intending any limitation Cₓ (sunload sensor data), Cₓ₁ (total drive time), Cₓ₂ [externally supplied (e.g. cloud-sourced) weather data], and others.

In other embodiments, a suitable windscreen re-freezing benchmark or threshold value is provided by a predetermined windscreen temperature at which re-freezing is likely (T_{REFREEZE}), and a determination is made of the amount of conditioned air (if any) required to raise an exterior temperature of the windscreen (T_{GLASSext}) to above T_{REFREEZE}. T_{REFREEZE} may be set at a predetermined ambient temperature threshold or benchmark whereby windscreen re-freezing is possible or likely, such as 0° F.

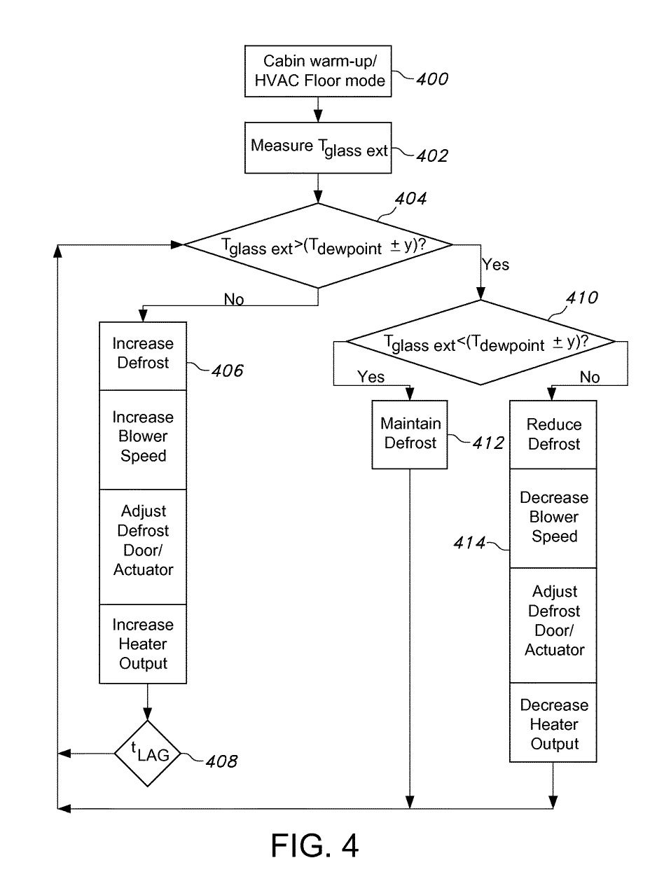

With reference to FIG. 4, in an embodiment a method according to the present disclosure for reducing risk of windscreen re-freezing includes, after passenger cabin warm-up and entering floor mode (step 400) as described above, determining an exterior windscreen temperature (T_{GLASSext}; step 402) such as by a suitable temperature sensor 222a as described above. Next, a determination is made as to whether T_{GLASSext}>T_{REFREEZE} (step 404). If not, at step 406 a defrost function is increased substantially as described above. After a predetermined time interval (t_{lag}; step 408), steps 404 and 406 are repeated.

If T_{GLASSext}>T_{REFREEZE}, at step 410 after a predetermined time period a subsequent determination is made whether T_{GLASSext}<T_{DEWPOINT}. If so, a current defrost flow is maintained (step 312) to continue to increase T_{GLASSext}. If at step 412 T_{GLASSext}>T_{REFREEZE}, this indicates that the risk of re-freezing is averted and that the defrost flow may be safely reduced (step 414), such as (with reference to FIG. 2) by one or more of adjusting the HVAC 212 blower speed, by adjusting defrost flow control door 218 to decrease the airflow to windscreen 206, by reducing the HVAC 212 heater core output, etc. In this manner, defrost flow is maintained only sufficiently to keep T_{GLASSext}>T_{REFREEZE}, thus avoiding the need for a constant increased defrost airflow and attendant energy costs and other disadvantages as summarized above.

As set forth above in the discussion of the fogging threshold value, the re-freezing threshold value may be adjusted as necessary according to other inputs influencing T_{REFREEZE} as will be discussed. As will appreciated, T_{REFREEZE} occurs when T_{GLASSext}<0° C. In use, the described system controls for T_{GLASSext} to keep that value higher than T_{REFREEZE} plus a safety factor. In embodiments, T_{REFREEZE} may be expressed as a function F of various relevant inputs, including exterior/ambient temperature, vehicle speed, defrost airflow velocity, and defrost airflow temperature. Other potential inputs relevant to T_{REFREEZE} include sun load/direction, rainfall, wiper settings, and others.

Ideally, T_{GLASSext} could be accurately measured at all points across the vehicle windshield, such as by infrared camera technology. In practice, however, vehicle manufacturers can include only limited numbers of sensors for gauging factors that may contribute to (T_{GLASSint}, T_{EXT}, etc.) and uncertainty is introduced into the calculations. In embodiments wherein T_{REFREEZE} is used as the windscreen re-freezing benchmark or threshold value, the described method contemplates adjusting that threshold value according to measured vehicle speed (V_{SPEED}), measured exterior ambient temperature (T_{EXT}), and defroster flow rate (DEF FLOW), and defroster temperature (T_{DEF}) according to a formula:

T_{GLASSext}≈[(DEF FLOW)·(T_{DEF})]−[(V_{SPEED})·(T_{DEF})]/(T_{EXT})]/(DEF FLOW)+[(V_{SPEED}) (6)

In embodiments, T_{REFREEZE} (a minimum target for T_{GLASSext}) is estimated:

T_{REFREEZE}=T_{EXT}+C₂(V_{SPEED})+C₄[(DEF FLOW)·(T_{DEF})] (7); or

T_{REFREEZE}=T_{EXT}+C₂(V_{SPEED})+C₄[(DEF FLOW)·(T_{DEF})]+C₃ (rain sensor signal) (8).

Of course, other factors could be considered and included as described above including Cₓ (sunload sensor data), Cₓ₁ (total drive time), Cₓ₂ [externally supplied (e.g. cloud-sourced) weather data], and others.

Thus, it will be appreciated that by the above teachings systems and methods are provided for vehicle windscreen defogging/re-freezing prevention which advantageously provide energy savings compared to conventional systems/methods. The described systems and methods allow window defogging/re-freezing prevention during vehicle operation, yet obviate any need for a constant, consistently increased defrost airflow and attendant energy costs and other disadvantages. Obvious modifications and variations are possible in light of the above teachings. All such modifications and variations are within the scope of the appended claims when interpreted in accordance with the breadth to which they are fairly, legally and equitably entitled.

What is claimed:

1. A method for prevention of fogging or re-freezing of a vehicle windscreen, comprising:
by one or more controllers, calculating a windscreen interior surface dew point temperature value and/or a probability value of a windscreen interior surface fogging and/or exterior surface re-freezing; and
providing only a sufficient conditioned airflow to the windscreen to prevent the calculated fogging and/or re-freezing probability value from exceeding a predetermined fogging and/or re-freezing risk threshold value.

2. The method of claim 1, including configuring the one or more controllers to perform the calculating and the providing only a sufficient conditioned airflow after an initial vehicle passenger cabin warm-up period and when a heating, ventilation, and cooling (HVAC) system of the vehicle is operating in a floor mode.

3. The method of claim 2, including providing an HVAC system including at least one actuator operatively connected to the one or more controllers and to at least one door associated with at least one windscreen defrost duct.

4. The method of claim 3, including configuring the one or more controllers to translate the door between a closed configuration, a fully open configuration, and at least one intermediate configuration.

5. The method of claim 1, including providing the only a sufficient conditioned airflow to cause a windscreen interior surface temperature value to exceed the windscreen interior surface dew point temperature value or to cause a windscreen exterior surface temperature value to exceed a windscreen exterior surface freezing temperature.

6. The method of claim 5, including, by the one or more controllers, receiving one or more inputs influencing the windscreen interior surface fogging and/or exterior surface re-freezing probability value and/or the windscreen direct dew point temperature value.

7. The method of claim 6, including providing the one or more received inputs to the one or more controllers by one or more of the group consisting of a sun load/direction sensor, a rain sensor, a passenger cabin relative humidity sensor, a windscreen relative humidity sensor, a windscreen interior surface temperature sensor, a windscreen exterior surface temperature sensor, a passenger cabin temperature sensor, a vehicle occupant sensor, a vehicle speed sensor, a wind speed/direction sensor, a vehicle-associated exterior ambient temperature sensor, a vehicle occupant, an electronic automatic temperature control (EATC) module, a remote temperature sensor, a remote humidity sensor, and crowd-sourced data.

8. The method of claim 7, including adjusting the windscreen interior surface dew point temperature value by one or more of the measured or received inputs.

9. The method of claim 7, including adjusting the exterior surface freezing temperature by one or more of the measured or received inputs.

10. The method of claim 1, including configuring the one or more controllers to repeat the steps of calculating and providing at predetermined spaced time intervals.

11. A system for prevention of fogging or re-freezing of a vehicle windscreen, comprising:
one or more controllers; and
a vehicle heating, ventilation, and cooling (HVAC) system including at least one actuator operatively connected to the one or more controllers and to at least one door associated with at least one windscreen defrost duct;
wherein the one or more controllers are configured to calculate a windscreen interior surface dew point temperature value and/or a probability value of a windscreen interior surface fogging and/or exterior surface re-freezing, and to cause the HVAC system to provide only a sufficient conditioned airflow to the windscreen to prevent the calculated fogging and/or re-freezing probability value from exceeding a predetermined fogging and/or re-freezing risk threshold value.

12. The system of claim 11, wherein one or more controllers are configured to perform the calculating and the causing the HVAC system to provide the only a sufficient conditioned airflow after an initial vehicle passenger cabin warm-up period and when the HVAC system is operating in a floor mode.

13. The system of claim 11, wherein the one or more controllers are further configured to translate the door between a closed configuration, a fully open configuration, and at least one intermediate configuration.

14. The system of claim 11, wherein the one or more controllers are further configured to provide the only a sufficient conditioned airflow to cause a windscreen interior surface temperature value to exceed the windscreen interior surface dew point temperature value or to cause a windscreen exterior surface temperature value to exceed a windscreen exterior surface freezing temperature.

15. The system of claim 11, wherein the one or more controllers are further configured to receive one or more inputs influencing the windscreen interior surface fogging and/or exterior surface re-freezing probability value and/or the windscreen direct dew point temperature value.

16. The system of claim 15, further including one or more devices for providing the one or more inputs selected from the group of devices consisting of a sun load/direction sensor, a rain sensor, a passenger cabin relative humidity sensor, a windscreen relative humidity sensor, a windscreen interior surface temperature sensor, a windscreen exterior surface temperature sensor, a passenger cabin temperature sensor, a vehicle occupant sensor, a vehicle speed sensor, a wind speed/direction sensor, a vehicle-associated exterior ambient temperature sensor, an HVAC system control panel, an electronic automatic temperature control (EATC) module, a receiver for remote temperature data, a receiver for remote humidity data, and a receiver for crowd-sourced data.

17. The system of claim 16, wherein the one or more controllers are further configured to adjust the windscreen interior surface dew point temperature value by one or more of the measured or received inputs.

18. The system of claim 16, wherein the one or more controllers are further configured to adjust the exterior surface freezing temperature value by one or more of the measured or received inputs.

19. The system of claim 11, wherein the one or more controllers are further configured to repeat the calculating and the causing the HVAC system to provide the only a sufficient conditioned airflow at predetermined spaced time intervals.

20. A vehicle including the system of claim 11.
